(19) United States
(12) Patent Application Publication
(10) Pub. No.: US 2004/0137907 A1
(43) Pub. Date: Jul. 15, 2004

(54) Method for management of wireless channel to wireless IP terminals in wireless LAN based access point

(76) Inventor: Jung-Sik Kim, Seoul (KR)

Correspondence Address: Robert E. Bushnell, Suite 300, 1522 K Street, N.W., Washington, DC, 20005, US

(21) Appl. No.: 10/746,337

(22) Filed: Dec. 29, 2003

(30) Foreign Application Priority Data
Jan. 3, 2003 (KR) 2003-352

(51) Int. Cl. H04Q 7/20; H04B 7/00

(52) U.S. Cl. 455/450; 455/509

(57) ABSTRACT

A method for management of a wireless channel to wireless IP terminals in a wireless LAN based AP (Access Point) includes: segmenting a wireless channel that is serviceable to each of wireless IP terminals registered to the LAN into a plurality of time slots; assigning a wireless channel for a predetermined time by sequentially allocating a time slot to one of the registered wireless IP terminals, which has a wireless channel occupancy permission, and; establishing a wireless channel between the AP and each of the wireless IP terminals having an assigned wireless channel per time slot, according to the sequentially allocated time slot, and transmitting a packet data in a fixed size to, and receiving a packet data from, the AP via the wireless channel. The method can be advantageously used for improving speech quality of a wireless IP phone by reducing a delay problem associated with channel assignment to wireless IP terminals and a jitter problem caused by changing data size.

### CLAIM OF PRIORITY

This application makes reference to, incorporates the same herein, and claims all benefits accruing under 35 U.S.C. § 119 from an application for “METHOD FOR MANAGEMENT OF THE WIRELESS CHANNEL TO WIRELESS IP TERMINALS IN THE ACCESS POINT WIRELESS LAN BASED” earlier filed in the Korean Intellectual Property Office on 3 Jan. 2003 and there duly assigned Serial No. 2003-352.

### BACKGROUND OF THE INVENTION

1. Field of the Invention

The present invention relates, in general, to a method for management of wireless channels to wireless Internet protocol (IP) terminals in a wireless local area network (LAN) based AP (Access Point), and more specifically, to a method for providing good speech quality to wireless IP terminals by more efficiently allocating the limited wireless channel resources to a plurality of IP terminals in the wireless LAN based AP.

2. Description of Related Art

Wireless IP terminals (hereinafter referred to as “IP terminals”) are terminals utilizing a wireless Internet Protocol (hereinafter referred to as “wireless IP”) network, including IP phones, IP handsets, Personal Computers (PCs), etc.

Compared to others, IP phones provide relatively low speech quality mainly because of technical problems associated with IP networks such as delay, jitter and loss.

Thanks to the development of many techniques for securing high-speed network equipment and Quality of Service (QoS), however, wired network based IP phones are capable of providing much enhanced speech quality to subscribers. However, if a wireless LAN is involved, the speech quality is not as good as wired network based IP phones. This basically contributes to the characteristics of a wireless network itself

In other words, when utilizing data in general and voice data together, the speech quality was severely lowered partially because of the Carrier Sense Multiple Access with Collision Avoidance (CSMA/CA) scheme, one of the wireless LAN protocols, and partially because of the half duplex property of a wireless network. Here, the half duplex property means only one of the transmission (Tx) mode or the receiving (Rx) mode can be run.

According to the CSMA/CA protocol of IEEE (Institute of Electrical and Electronics Engineers) 802.11, the AP communicates with each of the IP terminals and PCs.

That is, either AP or IP terminal first checks whether there is a carrier, conforming to the CSMA/CA protocol, and if there is no carrier (i.e., there is no terminal using a wireless channel), data transmission is done within a given time. At this point, since the transmission media (in this case, air) is equivalent for Tx and Rx, only one of two (Tx and Rx) is available at one time.

In addition, if there is a conflict with another IP terminal during data transmission, the AP selects a next carrier, according to a Back-off algorithm.

Every terminal connected to the AP, depending on the usage, has a different size for data to be transmitted or received. Hence, the size of a frame to be transferred changes as well, proportional to the size of data to be transmitted.

Therefore, if each of the IP terminals triggers a scramble for a channel according to the Back-off algorithm, the old-fashion Carrier Sense Multiple Access with Collision Detect (CSMA/CD) protocol, there is no guarantee that the channel will be available for the IP terminal, the current user of the channel, next time again.

IP phones, in general, can reproduce voice in real time mode only if they receive a voice data at least once in 10-30 msec (millisecond). However, if they cannot use channels to transmit voice data when needed, a good-quality speech quality is not promised.

When the traditional method is used, the medium access control (MAC) frame size used in a terminal such as a PC with widely fluctuating data transmission quantities is substantially changed. In other words, eliminating a header and FCS (frame check sequence), a frame body, the data section, has a very wide range from 0 to 2312 bytes. As such, even though an IP phone terminal and a general IP terminal take turns to transmit data, since the channel occupancy by the general IP terminal changes every time and thus, data jitter of the IP phone becomes great, the voice quality is inevitably deteriorated.

Originally, an IP phone alternates transmission (talking) and receiving (listening). Thus one-sided data transmission (e.g., an AP exclusively transmit data and thus an IP phone terminal is not able to transmit data at all) contributes to a one-way characteristic on both ends of the IP phone. For example, according to the one-way characteristic, a caller can hear the other party's voice but the other party cannot hear the caller's voice, or vice versa.

Therefore, to transmit/receive a voice data with a good speech quality, wireless IP phones should be able to use a channel, while alternating in transmission mode and receiving mode at regular intervals.

However, if the network is extended by connecting the wireless IP phones to the general PCs, the wireless IP terminals have to transmit their own voice data but also the voice data from those PCs. At this time, the voice data size is typically 100 bytes, and that of the PCs are usually greater than several hundreds of bytes. In case a PC user does something over the Internet while making a call using the wireless IP phone, the speech quality of the voice data through the wireless IP phone gets even worse because of a wide difference between delay and jitter, in proportion to the Internet usage by the PC.

### SUMMARY OF THE INVENTION

An object of the invention to solve at least the cited problems and/or disadvantages and to provide at least the advantages described hereinafter.

Accordingly, one object of the present invention is to solve the foregoing and other problems by providing a method for management of a wireless channel to wireless IP terminals in the wireless LAN based AP, to provide good speech quality to wireless IP terminals by more efficiently allocating wireless channel resources that are limited to a plurality of IP terminals in a wireless LAN based AP.

Another object is for a wireless LAN based AP assigning a time slot to each of the wireless IP terminals being registered to its network, and permitting each wireless IP terminals to use a wireless channel according to the time slot and then the wireless IP terminal transmitting a data packet in a fixed size per time slot.

It is yet another object to provide a wireless IP phone whose major function is to provide users with phone service to be able to transmit voice data at regular intervals even in a mixed environment with a data network.

It is still another object to provide an apparatus and technique for greatly reducing delay and jitter problems and significantly improving voice (tone) quality of a wireless IP phone.

It is another object to provide a technique for management of a wireless channel to wireless IP terminals in the wireless LAN based AP that is easy and inexpensive to implement and yet be more efficient.

The foregoing and other objects and other advantages are realized by providing a method for management of a wireless channel to wireless IP terminals in a wireless LAN based AP, which includes: segmenting a wireless channel that is serviceable to each of the wireless IP terminals registered to the LAN into a plurality of time slots; assigning a wireless channel for a predetermined time by sequentially allocating a time slot to one of the registered wireless IP terminals, which has a wireless channel occupancy permission, and; establishing a wireless channel between the AP and each of the wireless IP terminals having an assigned wireless channel per time slot, according to the sequentially allocated time slot, and transmitting a packet data in a fixed size to, and receiving a packet data from, the AP via the wireless channel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram illustrating an AP system in a wireless or wired network according to the related art;

FIG. 2 diagrammatically depicts a MAC frame of the related art;

FIG. 3 is a schematic diagram of a system for describing a method for management of a wireless channel to wireless IP terminals in a wireless LAN based AP;

FIG. 4 is an exemplary diagram, in which a time slot is assigned to a wireless IP terminal that requests to use a channel;

FIG. 5 is an exemplary diagram of a packet frame for transmitting/receiving data with an IP terminal according to the present invention;

FIG. 6 is a flow chart describing the method for management of a wireless channel to wireless IP terminals in a wireless LAN based AP; and

FIG. 7 is a detailed flow chart describing a step for updating channel assignment information in FIG. 6.

### DETAILED DESCRIPTION OF EXEMPLARY EMBODIMENTS

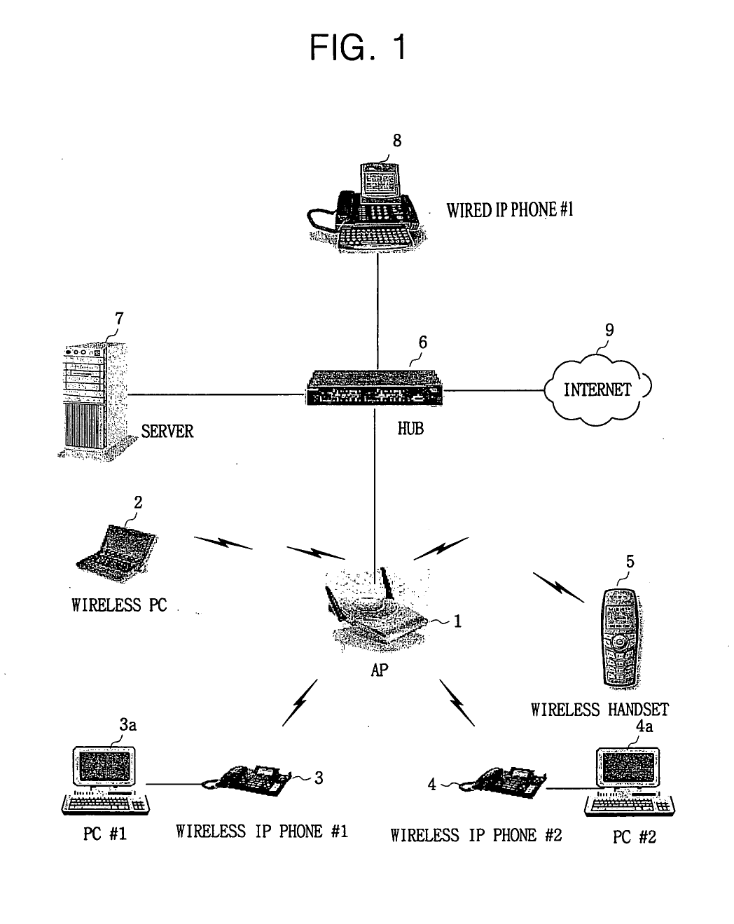

Turning now to the drawings, FIG. 1 is a schematic diagram of an AP system run in a wired or wireless network.

Referring to FIG. 1, AP (1) is connected to a wireless PC (2), a first wireless IP phone (exemplified as wireless IP phone #1) (3), a second wireless IP phone (exemplified as wireless IP phone #2) (4), and a wireless IP handset (5), and via a hub (6) connected through a wired network, the AP 1 is also connected to a server (7), a first wired IP phone (exemplified as wired IP phone #1) 8, and Internet network (9). The first wireless IP phone (3) and the second wireless IP phone (4) are connected to PC#l (3a) and PC#2 (4a), respectively.

In the wired/wireless system with the above configuration, the wireless IP phone #1 (3) can make calls to other IP phones such as the wireless IP phone #2 (4), the wired IP phone #1 (8), and the wireless IP handset (5). The personal computers PC#1 (3a) and PC#2 (4a) being connected to a wireless network can use the server connected to a wired network or Internet (9) through the AP (1).

According to the CSMA/CA protocol of IEEE (Institute of Electrical and Electronics Engineers) 802.11, the AP 1 communicates with each of the IP terminals (2, 3, 4, 5, and 8), and PCs (3a and 4a).

That is, either AP or IP terminal first checks whether there is a carrier, conforming to the CSMA/CA protocol, and if there is no carrier (i.e., there is no terminal using a wireless channel), data transmission is done within a given time. At this point, since the transmission media (in this case, air) is equivalent for Tx and Rx, only one of two (Tx and Rx) is available at one time.

In addition, if there is a conflict with another IP terminal during data transmission, the AP selects a next carrier, according to Back-off algorithm.

Every terminal connected to the AP, depending on the usage, has a different size for data to be transmitted or received. Hence, the size of a frame to be transferred changes as well, proportional to the size of data to be transmitted.

Therefore, if each of the IP terminal triggers a scramble for a channel according to the Back-off algorithm, the old-fashion Carrier Sense Multiple Access with Collision Detect (CSMA/CD) protocol, there is no guarantee that the channel will be available for the IP terminal, the current user of the channel, next time again.

IP phones, in general, can reproduce voice in real time mode only if they receive a voice data at least once in 10-30 msec (millisecond). However, if they cannot use channels to transmit voice data when needed, a good-quality speech quality is not promised.

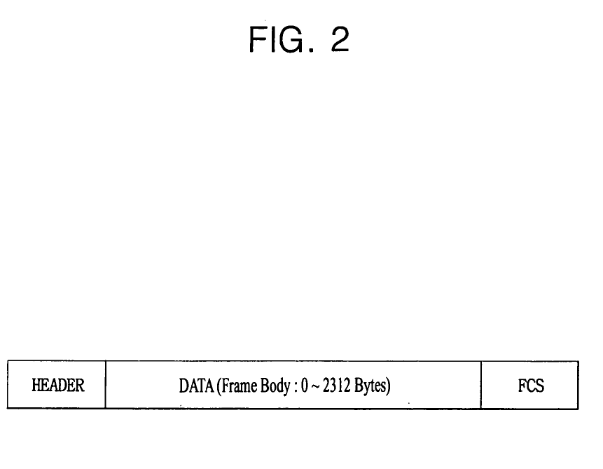

When the traditional method is used, the medium access control (MAC) frame size used in a terminal such as a PC with widely fluctuating data transmission quantities is substantially changed, as illustrated in FIG. 2. In other words, eliminating a header and FCS, a frame body, the data section, has a very wide range from 0 to 2312 bytes. As such, even though an IP phone terminal and a general IP terminal take turns to transmit data, since the channel occupancy by the general IP terminal changes every time and thus, data jitter of the IP phone becomes great, the voice quality is inevitably deteriorated.

Originally, an IP phone alternates transmission (talking) and receiving (listening). Thus one-sided data transmission (e.g., an AP exclusively transmit data and thus an IP phone terminal is not able to transmit data at all) contributes to a one-way characteristic on both ends of the IP phone. For example, according to the one-way characteristic, a caller can hear the other party's voice but the other party cannot hear the caller's voice, or vice versa.

Therefore, to transmit/receive a voice data with a good speech quality, wireless IP phones 3 and 4 should be able to use a channel, while alternating in transmission mode and receiving mode at regular intervals.

As shown in FIG. 1, however, if the network is extended by connecting the wireless IP phones (3 and 4) to the general PCs (3a and 4a), the wireless IP terminals 3 and 4 have to transmit their own voice data but also the voice data from those PCs (3a and 4a). At this time, the voice data size is typically 100 bytes, and that of the PCs (3a and 4a) are usually greater than several hundreds of bytes. In case a PC user does something over the Internet while making a call using the wireless IP phone (3 or 4), the speech quality of the voice data through the wireless IP phone (3 or 4) gets even worse because of a wide difference between delay and jitter, in proportion to the Internet usage by the PC (3a or 4a).

Reference will now be made in detail to exemplary embodiments of the present invention, which are illustrated in the accompanying drawings.

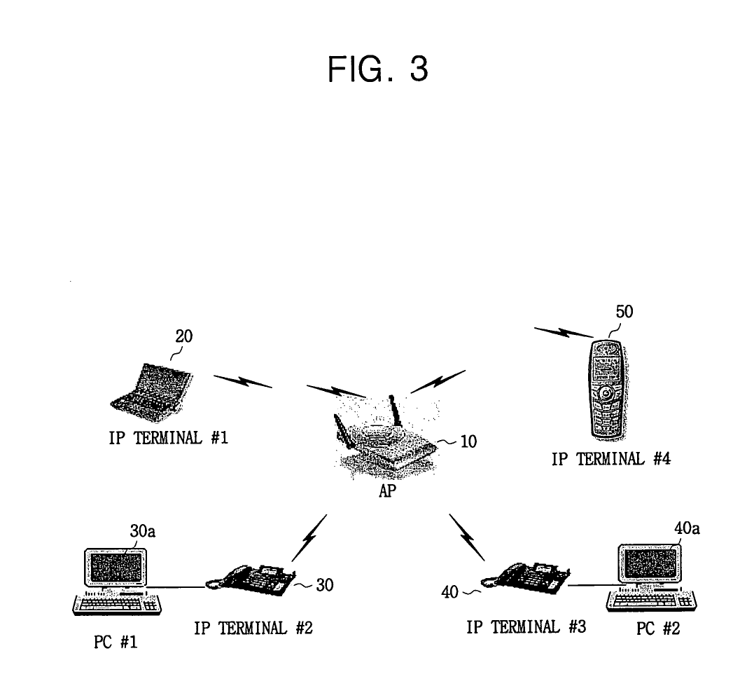

FIG. 3 is a schematic diagram of a system for describing a method for management of a wireless channel to wireless IP terminals in a wireless LAN based AP.

Referring to FIG. 3, a wireless LAN based AP (10) is connected to a plurality of wireless IP terminals via a wireless LAN.

Wireless IP terminals being registered to the wireless LAN of the AP (10) include a wireless PC (IP Terminal #1) (20), a wireless IP phone #1 (IP Terminal #2) (30) connected to a PC #1 (30a), a wireless IP phone #2 (IP Terminal #3) (40) connected to a PC #2 (40a), and a wireless IP handset (IP Terminal #4) (50).

As a convenience in explaining that all the above IP phones operate in a wireless network, those wireless PCs and the IP phones are given numerals, such as, the IP terminal #1 (20) represents the wireless PC, the IP terminal #2 (30) represents the wireless IP phone #1, the IP terminal #3 (40) represents the wireless IP phone #2, and the IP terminal #4 (50) represents the wireless IP handset.

The AP (10) assigns a certain amount of time to each of the wireless IP terminals for using a wireless channel, and transmits a packet data having a fixed size to, and receives the packet data from, each of the wireless IP terminals.

In so doing, the delay problem, which is often observed in the related art primarily because some terminals were not assigned with a channel they need, is naturally solved.

Moreover, since the data to be transmitted to, and received from, each of the wireless IP terminals is framed with a fixed size, the jitter problem, which is usually caused by the fluctuation of data size, can be prevented. In consequence, users are provided with superior speech quality.

Each wireless IP terminal's identifier information is registered to the AP (10). Moreover, the AP (10) assigns a discrete number to each of the registered IP terminals, and reserves time for activation (it is the time for an IP terminal to use a channel for data transmission), registration or management of wireless channels.

Hence, if a wireless IP terminal has a data to be transmitted to, and to be received from, the AP (10), requests the AP during the time for registration or management to assign a wireless channel, and as a response, the AP assigns time to the corresponding wireless IP terminal for using a corresponding wireless channel. Within the given time, the IP terminal transmits a packet data to, and receives a packet data from, the AP.

On the other hand, if the AP has a data to be transmitted to a certain wireless IP terminal, the AP (10) assigns a wireless channel to the corresponding IP terminal and communicated therewith. Here, the AP can increase or decrease the number of time slots to be activated, depending on the number of IP terminals, up to a point where speech quality is yet secured. Also, depending on whether an IP phone's channel is being used, the AP (10) can increase or decrease the fixed frame size, to enhance data transmission capacity.

Each of the wireless IP terminals is initially registered to the AP when the power is on, and the AP manages each terminal as a discrete identifier (ID). That is, when each of the wireless IP terminals is powered, the wireless IP terminals forward their own information to the AP. Upon receiving the terminal information from each of the wireless IP terminal, the AP assigns an ID (identification) to a corresponding wireless IP terminal and registers the ID to a database.

To assign a wireless channel to each of the wireless IP terminal, the AP (10) assigns a time slot in sequence to each wireless IP terminal with a permission of wireless channel occupancy, and then designates a next time slot as a time slot for channel assignment information change within one cycle. The time slot for channel assignment information change is called a registration time slot.

The channel assignment information change means updating channel assignment information by reallocating channels based on the current wireless channel assignment information as a wireless IP terminal without an assigned time slot sends a new wireless channel occupancy request.

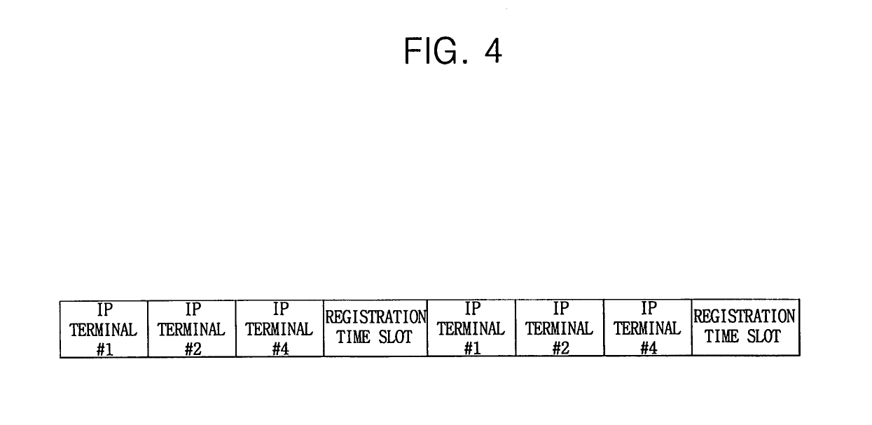

FIG. 4 is an exemplary diagram in which the AP (10) assigns time slots to wireless IP terminals that request channels. For instance, if IP terminals (1, 2 and 4) want communications, the AP assigns a wireless channel as depicted in the drawing. At this time, half of the time slot is in transmission mode, and the half in receiving mode.

In FIG. 4, the registration time slot is used as a transmission channel of data associated with registration, channel request or management between IP terminals and the AP.

As discussed before, the IP terminal #1 (20), followed by the IP terminal #2 (30), and the IP terminal #4 (50), transmits data to, and receives data from, the AP (10) via a wireless channel.

Among IP terminals without any assigned registration time slot, a terminal having a high priority transmits to the AP information about its availability and other necessary information. This is purely for improving speech (voice) quality. Therefore, the terminal having a high priority naturally means an IP phone for transmitting/receiving voice data only. The AP updates channel registration data when an additional channel usage request is received at the time of data transmission. Also, the AP grants registration permission (or admission) to a new IP terminal when requested, and transmits the updated channel registration data.

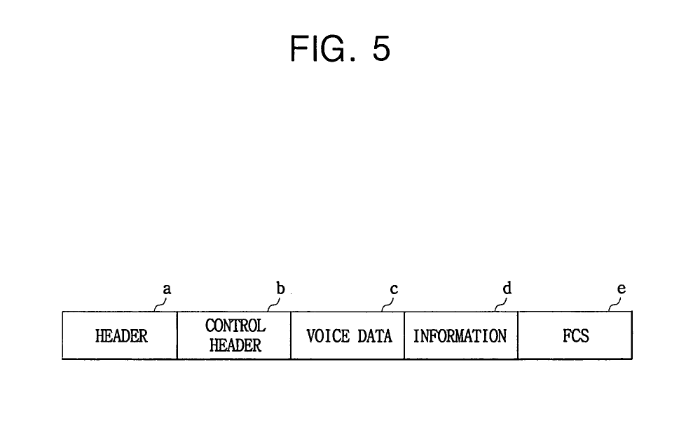

FIG. 5 illustrates a frame format that is actually communicated between wireless IP terminals and the AP.

Each packet frame has a fixed size. In general, a packet frame is composed of a header section (a and b) for displaying the kinds of data, a voice data section (c) for providing voice service, and information data section (d) for providing data service, and an FCS section (e).

Occupancy percentages of the voice data section and the information data section in the fixed-sized packet frame can vary. On the other hand, the size of the entire frame is fixed by the AP. Particularly, for the purpose of improving performance, the frame size is cut down as the number of terminals to be activated is increased, while the frame size is enlarged as the number of terminals to be activated is decreased.

The header (a) in FIG. 5 is the IEEE802.11 use header. Meanwhile, the control header (b) is newly added to compensate tone quality, and has information about actual data. These two are included in the front header (a).

In particular, the control header can be used for distinguishing voice data from information data, using 2-bit for displaying types. For instance, ‘00’ indicates voice data only, and ‘01’ indicates a mixture of voice data and information data, ‘11’ indicates information data only, and ‘10’ indicates reserved data.

The following 8 bits correspond to the size of voice data, and another 8 bits thereafter correspond to the size of general data. As in ‘00’ or ‘11’, even the same kind of data is separately indicated.

Here, the data is set as 8 bits because the voice data is smaller than 256 bytes. Depending on the performance and kinds of voice CODEC (coder/decoder) being used, the data size can be designated differently. PAD (a pad field appends or “pads” extra data bytes to this field to bring a frame length to a certain size) can be optionally added if the frame size is different from the regulated one.

Fixing the frame size, it is possible to facilitate processing received data, and to minimize jitter over the wireless network.

The AP, if necessary, for example, to improve tone quality of an IP phone, can control or suppress channel usage of a general data use terminal (PC) especially when an IP phone terminal requests a call.

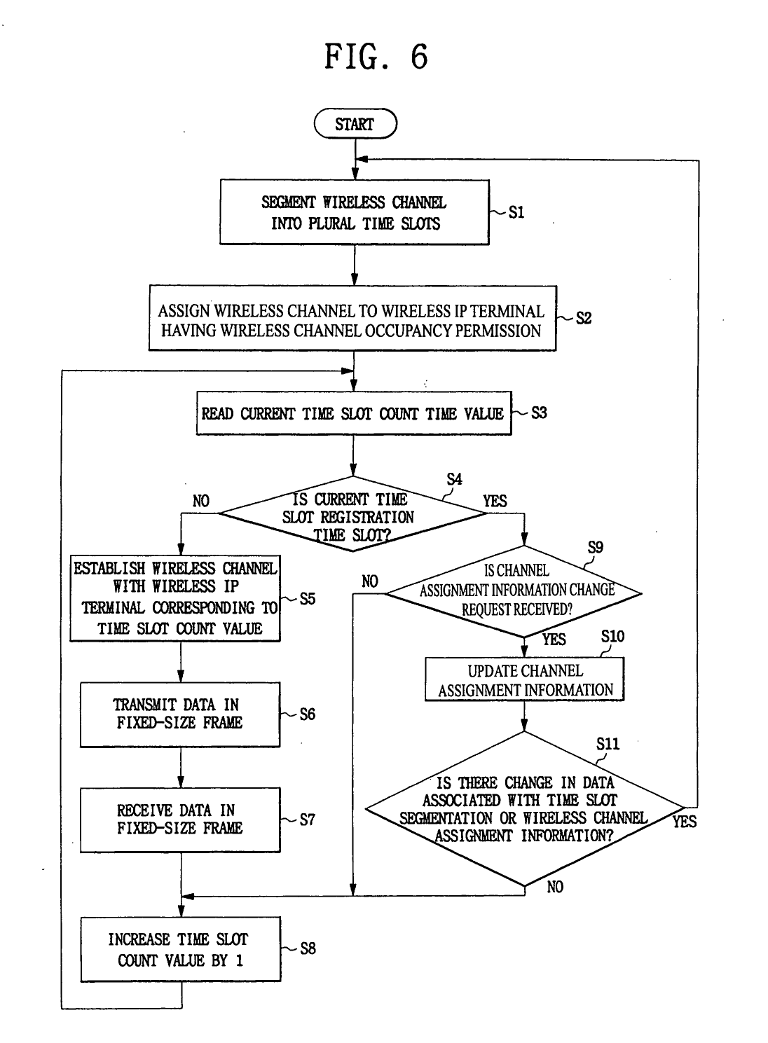

FIG. 6 is a flow chart describing the method for management of a wireless channel to wireless IP terminals in a wireless LAN based AP.

Referring to FIG. 6, an available wireless channel is segmented into a plurality of time slots according to time so that each of the wireless IP terminals can occupy the wireless channel for a predetermined time (S1). At this time, the number of time slots can vary, depending on the number of the wireless IP terminals, within an extent where the speech quality of the wireless IP terminals is yet secured.

When one wireless channel is segmented into a plurality of time slots, reading a channel assignment database, each of the wireless IP terminals with a wireless channel occupancy permission is assigned with one time slot for a predetermined time (S2).

Then, the AP communicates with each of the wireless IP terminals according to the time slot. To do so, a current time slot count value is first read (S3), and it is decided whether the current time slot is a registration time slot (S4).

If it turns out that the current time slot is not the registration time slot, the AP establishes a wireless channel with a wireless IP terminal corresponding to the time slot count value (S5). When the wireless channel is established between the AP and the wireless IP terminal, half of the time given to one time slot is spent for transmitting data in a frame via the wireless channel (S6). The frame size for data transmission is predetermined.

If the transmission mode out of one time slot is terminated, data in a fixed frame size is received from a wireless IP terminal for which a wireless channel is established by having been operated in receiving mode for the other half of the time (S7). Again, the frame size for receiving data is predetermined. When the transmission mode and the receiving mode are completed in one time slot in this manner, the time slot count value is increased by 1 (S8).

In the meantime, if the current time slot turns out to be the registration time slot, first of all, it is decided whether a channel assignment information change request is received (S9). If there is no such request, the time slot count value is increased by 1 for data processing in a following time slot (S8), and the current time slot count value is read (S3).

However, if there is a request for channel assignment information change, channel assignment information should be updated accordingly (S10). After updating the channel assignment information, it is decided whether there is any change in time slot segmentation or wireless channel assignment among the updated channel assignment information (S11).

In case there is no change made in the information associated with time slot segmentation or wireless channel assignment despite the channel assignment information update, the time slot count value is increased by 1 for data processing in a following time slot (S8), and the current time slot count value is read (S3).

However, the information associated with time slot segmentation or wireless channel assignment is changed at the time of updating the channel assignment information, one wireless channel is segmented into a plurality of time slots again (S1), on the basis of the change being made in time slot segmentation or wireless channel assignment.

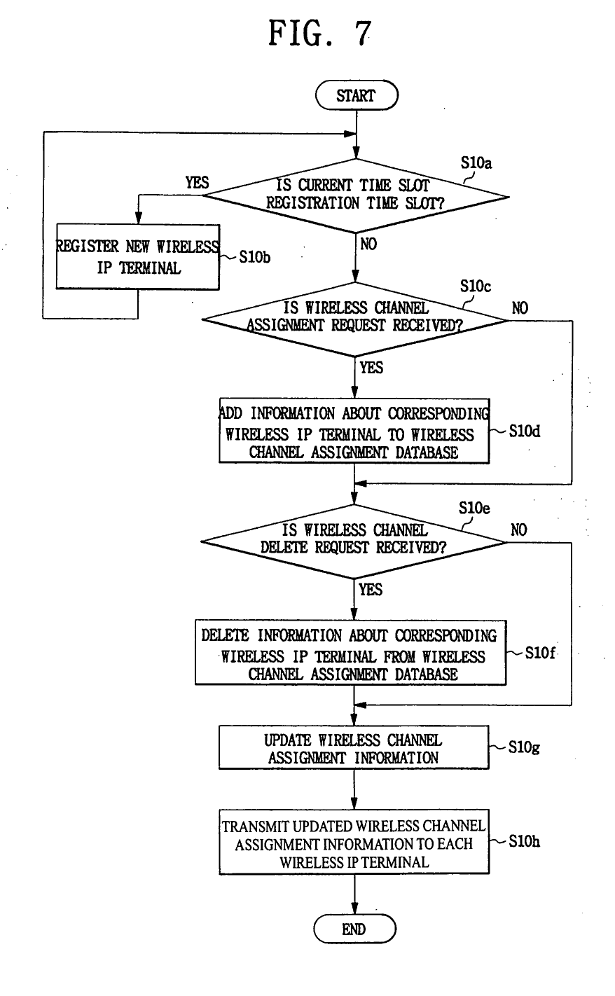

FIG. 7 is a detailed flow chart describing the step (S10) for updating channel assignment information in FIG. 6. Referring to FIG. 7, it is first decided whether a new wireless IP terminal sends a service registration request (S10a).

The AP receives the service registration request from each of the wireless IP terminals in its wireless LAN. The service registration request and information about a corresponding wireless IP terminal is automatically sent as soon as the wireless IP terminal is powered. Therefore, the service registration for a new wireless IP terminal takes place any time.

If it turns out that a new wireless IP terminal requests the service registration, the new wireless IP terminal is registered as a new one (S10b).

If there is no such request from a new wireless IP terminal, it is decided whether one of the wireless IP terminals, that is already service-registered but not having an assigned wireless channel, has requested a new wireless channel (S10c).

If one of those wireless IP terminals requests to assign a new wireless channel, information about the corresponding wireless IP terminal is added to the wireless channel assignment database (S10d).

Then, it is decided whether a wireless channel delete request is received (S10e). Actually, the wireless channel delete request is made by the AP. To be more specific, the AP finds out whether each of the wireless IP terminals already having an assigned time slot for occupying a wireless channel is actually using the wireless channel for the corresponding time slot, and if it is discovered that there is a certain wireless IP terminal that does not use the wireless channel, the AP decides to delete the corresponding wireless IP terminal from a list of wireless IP terminals to be assigned with a time slot. Therefore, if there is the wireless channel delete request, information about the corresponding wireless IP terminal is destroyed or deleted from the wireless channel assignment database (S10f).

Going through the above steps, the wireless channel assignment information is eventually updated (S10g) when the wireless channel assignment database is upgraded. This updated wireless channel assignment information is forwarded to each of the wireless IP terminals, whereby every wireless IP terminal having an assigned wireless channel can establish a wireless channel with the AP and transmit data to, and receive data from, the AP (S10h).

In conclusion, a wireless LAN based AP assigns a time slot to each of the wireless IP terminals being registered to its network, and permits each wireless IP terminals to use a wireless channel according to the time slot. Then the wireless IP terminal transmits a data packet in a fixed size per time slot. In this manner, a wireless IP phone whose major function is to provide users with phone service is able to transmit voice data at regular intervals even in a mixed environment with a data network. As a result, delay and jitter problems are greatly reduced and voice (tone) quality of a wireless IP phone is much improved.

While the present invention has been particularly shown and described with reference to exemplary embodiments thereof, it will be understood by those skilled in the art that the foregoing and other changes in form and details may be made therein without departing from the spirit and scope of the present invention.

What is claimed is:

1. A method for management of a wireless channel to wireless Internet protocol terminals in a wireless local area network based access point, the method comprising the steps of:
segmenting a wireless channel that is serviceable to each of wireless Internet protocol terminals registered to the local area network into a plurality of time slots;
assigning a wireless channel for a predetermined time by sequentially allocating a time slot to one of the registered wireless Internet protocol terminals, which has a wireless channel occupancy permission; and
establishing a wireless channel with each of the wireless Internet protocol terminals having an assigned wireless channel per time slot, according to the sequentially allocated time slot, and transmitting and receiving a packet data in a fixed size via the wireless channel.

2. The method according to claim 1, wherein the assigning of the wireless channel step is accomplished by sequentially allocating a time slot to each wireless Internet protocol terminal with a wireless channel occupancy permission, and then designating a following time slot as a time slot for channel assignment information change within one cycle.

3. The method according to claim 2, wherein the channel assignment information change involves updating channel assignment information by reassigning channels based on a current wireless channel assignment information as a wireless Internet protocol terminal without an assigned time slot sends a new wireless channel occupancy request, and transmitting the updated channel assignment information to each of the wireless Internet protocol terminals.

4. The method according to claim 1, wherein the packet frame in the fixed size is comprised of a header section for displaying the kinds of data, a voice data section for providing voice service, and information data section for providing data service, and a frame check sequence section.

5. The method according to claim 4, wherein occupancy percentages of the voice data section and the information data section in the packet frame having the fixed size are variable.

6. The method according to claim 1, wherein half of the time slot is assigned for a transmission mode and the other half is assigned for a receiving mode.

7. The method according to claim 1, wherein the number of the time slots is determined, depending on the number of wireless Internet protocol terminals being registered, as long as speech quality of the wireless Internet protocol terminals is secured.

8. The method according to claim 1, wherein the wireless Internet protocol terminal is one of a wireless Internet protocol phone, a wireless Internet protocol handset, and a personal computer.

9. The method according to claim 1, wherein the size of the packet frame is determined in consideration with characteristics of wireless Internet protocol terminals using the wireless channel.

10. The method according to claim 1, further comprising of:
deciding whether the current time slot is a registration time slot by reading a current time slot count value;
establishing a wireless channel with a wireless terminal corresponding to the time slot count value when the current time slot is not the registration time slot;
deciding whether a channel assignment information change request is received when the current time slot is the registration time slot; and
updating channel assignment information when there is a request for channel assignment information change.

11. A method for managing wireless channels, comprising:
segmenting a wireless channel, that is serviceable to each of a plurality of wireless terminals registered to a network, into a plurality of time slots;
assigning a wireless channel for a predetermined time by sequentially allocating a time slot to one of the registered wireless Internet protocol terminals, which has a wireless channel occupancy permission; and
establishing a wireless channel between an access point and each of the wireless terminals having an assigned wireless channel per time slot, according to the sequentially allocated time slot, and transmitting and receiving a packet data in a fixed size via the wireless channel.

12. The method according to claim 11, with the assigning of the wireless channel by sequentially allocating a time slot to each wireless terminal with a wireless channel occupancy permission, and then designating a following time slot as a time slot for channel assignment information change within one cycle.

13. The method according to claim 12, with the channel assignment information change involving updating channel assignment information by reassigning channels based on a current wireless channel assignment information as a wireless terminal without an assigned time slot, sending a new wireless channel occupancy request, and transmitting the updated channel assignment information to each of the wireless terminals.

14. The method according to claim 13, with the packet frame in the fixed size comprising of a header section for displaying the kinds of data, a voice data section for providing voice service, and information data section for providing data service, and a frame check sequence section.

15. The method according to claim 14, with occupancy percentages of the voice data section and the information data section in the packet frame having the fixed size are variable.

16. The method according to claim 15, with half of the time slot being assigned for a transmission mode and the other half is assigned for a receiving mode.

17. The method according to claim 16, with the number of the time slots being variable, depending on the number of wireless terminals being registered, as long as speech quality of the wireless terminals is secured.

18. The method according to claim 11, further comprising of:
deciding whether the current time slot is a registration time slot by reading a current time slot count value;
establishing a wireless channel with a wireless terminal corresponding to the time slot count value when the current time slot is not the registration time slot;
deciding whether a channel assignment information change request is received when the current time slot is the registration time slot; and
updating channel assignment information when there is a request for channel assignment information change.

19. An apparatus for managing wireless channels, comprising:
a plurality of wireless Internet protocol terminals; and
an access point sending and receiving information between the plurality of wireless Internet protocol terminals, the access point using a wireless local area network, the access point segmenting a wireless channel that is serviceable to each of wireless Internet protocol terminals registered to the local area network into a plurality of time slots, the access point assigning a wireless channel for a predetermined time by sequentially allocating a time slot to one of the registered wireless Internet protocol terminals, which has a wireless channel occupancy permission, and the access point establishing a wireless channel between the access point and each of the wireless Internet protocol terminals having an assigned wireless channel per time slot, according to the sequentially allocated time slot, and transmitting a packet data in a fixed size to, and receiving a packet data from the access point via the wireless channel.

20. The apparatus according to claim 19, with the packet frame in the fixed size comprising of a header section for displaying the kinds of data, a voice data section for providing voice service, and information data section for providing data service, and a frame check sequence section.

21. The apparatus according to claim 20, with occupancy percentages of the voice data section and the information data section in the packet frame including the fixed size being variable.

22. The apparatus according to claim 21, with one of the wireless Internet protocol terminals being one of a wireless Internet protocol phone, a wireless Internet protocol handset, and a personal computer.
